(19) United States
(12) Patent Application Publication
(10) Pub. No.: US 2025/0214655 A1
(43) Pub. Date: Jul. 3, 2025

(54) VEHICLE LOWER PART STRUCTURE

(71) Applicant: TOYOTA JIDOSHA KABUSHIKI KAISHA, Aichi-ken (JP)

(72) Inventors: Yasuhiro SHIRAI, Toyota-shi (JP); Katsuichiro HIRAKAWA, Seto-shi (JP); Hirokazu MAEDA, Nagoya-shi (JP); Yuki NISHIKAWA, Toyota-shi (JP); Junya MIYATAKE, Toyota-shi (JP)

(21) Appl. No.: 18/969,262

(22) Filed: Dec. 5, 2024

(30) Foreign Application Priority Data
Dec. 27, 2023 (JP) 2023-221551

(51) Int. Cl. B62D 25/02; B60K 1/04; B62D 21/15

(52) U.S. Cl. CPC B62D 25/025; B60K 1/04; B62D 21/157; B60K 2001/0438

(57) ABSTRACT

A vehicle lower part structure includes: a battery pack including a battery cell inside and disposed on a vehicle lower side with respect to a vehicle cabin of a vehicle; a rocker disposed on an outer side of the battery pack in a vehicle width direction and extending in a vehicle front-rear direction; a pair of support portions disposed at least partially between the battery pack and the rocker in the vehicle width direction when viewed in a vehicle up-down direction, and spaced away from each other in the vehicle front-rear direction; and a central framework extending in the vehicle width direction, positioned between the support portions in the vehicle front-rear direction, and including an end positioned on an inner side in the vehicle width direction with respect to the support portions.

### CROSS-REFERENCE TO RELATED APPLICATION

This application claims priority to Japanese Patent Application No. 2023-221551 filed on Dec. 27, 2023, incorporated herein by reference in its entirety.

### BACKGROUND

### 1. Technical Field

The present disclosure relates to a vehicle lower part structure.

### 2. Description of Related Art

Japanese Unexamined Patent Application Publication No. 2023-80379 (JP 2023-80379 A) discloses an invention relating to a vehicle underbody structure. In this vehicle underbody structure, a battery pack and a rocker overlap each other when viewed in a vehicle width direction, and the rocker includes a shock absorbing portion having hollows extending in a vehicle front-rear direction. When a collision load is input in the vehicle width direction, the peripheries of the hollows of the shock absorbing portion collapse, thereby absorbing the collision load and suppressing the input of the collision load to the battery pack.

### SUMMARY

When the collision load is input in the vehicle width direction, this collision load may be input to a battery cell in the battery pack depending on a deformation mode of the rocker.

The present disclosure provides a vehicle lower part structure that can suppress input of a collision load in a vehicle width direction to a battery cell in a battery pack by managing a deformation mode of a rocker.

A vehicle lower part structure according to one aspect includes: a battery pack including a battery cell inside and disposed on a vehicle lower side with respect to a vehicle cabin of a vehicle; a rocker disposed on an outer side of the battery pack in a vehicle width direction and extending in a vehicle front-rear direction; a pair of support portions disposed at least partially between the battery pack and the rocker in the vehicle width direction when viewed in a vehicle up-down direction, and spaced away from each other in the vehicle front-rear direction; and a central framework extending in the vehicle width direction, positioned between the support portions in the vehicle front-rear direction, and including an end positioned on an inner side in the vehicle width direction with respect to the support portions.

In the vehicle lower part structure according to the above aspect, the battery pack is disposed on the vehicle lower side with respect to the vehicle cabin, and includes the battery cell inside. The rocker extending in the vehicle front-rear direction is disposed on the outer side of the battery pack in the vehicle width direction. Therefore, when a collision load is input in the vehicle width direction, the collision load is input to the rocker before being input to the battery pack.

When the collision load is input in the vehicle width direction, this collision load may be input to the battery cell in the battery pack depending on a deformation mode of the rocker.

In this aspect, the pair of support portions is provided. At least part of the support portion is disposed between the battery pack and the rocker in the vehicle width direction when viewed in the vehicle up-down direction, and the support portions are disposed away from each other in the vehicle front-rear direction.

The central framework extending in the vehicle width direction is positioned between the support portions in the vehicle front-rear direction, and the end of the central framework is positioned on the inner side in the vehicle width direction with respect to the support portions.

Therefore, when the collision load is input to the rocker in the vehicle width direction, the rocker supported by the support portions is bent so that, when viewed in the vehicle up-down direction, the apex of the rocker is near the center of the portion of the rocker between the support portions in the vehicle front-rear direction. In this aspect, the vicinity of the apex of the rocker deformed by the collision load can be supported by the central framework, thereby suppressing transmission of the collision load toward the battery cell.

The vehicle lower part structure according to the above aspect may further include a support framework extending in the vehicle width direction on an inner side of the support portion in the vehicle width direction, and disposed to overlap the support portion when viewed in the vehicle width direction.

In the vehicle lower part structure according to the above aspect, the support framework is provided. The support framework extends in the vehicle width direction on the inner side of the support portion in the vehicle width direction, and is disposed to overlap the support portion when viewed in the vehicle width direction.

Therefore, in this aspect, when the collision load is input in the vehicle width direction, part of the load input to the support portion can be borne by the support framework.

In the vehicle lower part structure according to the above aspect, the central framework may be a battery cross member provided inside the battery pack.

In the vehicle lower part structure according to the above aspect, the vicinity of the apex of the rocker deformed by the collision load in the vehicle width direction can be supported by the battery cross member provided inside the battery pack. That is, in this aspect, the collision load can also be borne by the component inside the battery pack.

In the vehicle lower part structure according to the above aspect, a rigidity of the support framework against a load in the vehicle width direction may be higher than a rigidity of the battery cross member against the load.

In the vehicle lower part structure according to the above aspect, when the collision load is input to the rocker in the vehicle width direction, part of the load input from the rocker to the support portion is borne by the support framework as described above.

Depending on the rigidity of the support framework against the collision load in the vehicle width direction, there is a possibility that, when the collision load is input to the rocker, the rocker cannot maintain the support by the support framework and the entire rocker is pushed inward in the vehicle width direction.

In this aspect, the rigidity of the support framework against the load in the vehicle width direction is higher than the rigidity of the battery cross member against the load. This can increase the certainty that, when the load is input in the vehicle width direction, the load is borne by the support framework, and furthermore, increase the certainty that the vicinity of the apex of the rocker bent by the vehicle collision load is supported by the battery cross member.

In the vehicle lower part structure according to the above aspect, the rocker may include a weakened portion provided at a part positioned between the support portions in the vehicle front-rear direction, and having a lower rigidity against a load in the vehicle width direction than another part of the rocker.

In the vehicle lower part structure according to the above aspect, the weakened portion is provided at the part of the rocker positioned between the support portions in the vehicle front-rear direction. The rigidity of the weakened portion against the load in the vehicle width direction is lower than the rigidity of the another part of the rocker. Therefore, this aspect can increase the certainty that, when the collision load is input to the rocker in the vehicle width direction, the rocker is deformed at a point starting from the weakened portion. Thus, the deformation mode of the rocker can be managed more easily.

In the vehicle lower part structure according to the above aspect, a disposition position of the central framework and a disposition position of the weakened portion may be set as the same position in the vehicle front-rear direction.

In the vehicle lower part structure according to the above aspect, the disposition position of the central framework and the disposition position of the weakened portion of the rocker are set as the same position in the vehicle front-rear direction, thereby increasing the certainty that the vicinity of the apex of the rocker deformed by the collision load in the vehicle width direction is supported by the central framework.

The vehicle lower part structure according to the above aspect may further include a load transmitting member disposed inside the rocker and configured to transmit a load in the vehicle width direction to the support portion.

In the vehicle lower part structure according to the above aspect, the load transmitting member is disposed inside the rocker. The load transmitting member is configured to transmit the load in the vehicle width direction to the support portion. Therefore, in this aspect, when the collision load is input in the vehicle width direction, part of the collision load can be transmitted to the support portion via the load transmitting member even if the rocker is deformed by the collision load.

As described above, the vehicle lower part structure according to the present disclosure has an excellent effect that the input of the collision load in the vehicle width direction to the battery cell in the battery pack can be suppressed by managing the deformation mode of the rocker.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a plan view schematically showing the configuration of a vehicle to which a vehicle lower part structure according to an embodiment is applied;

FIG. 2 is a sectional view from a vehicle rear side (sectional view taken along line 2-2 in FIG. 1), schematically showing the configuration of a lower part of a vehicle body of the vehicle to which the vehicle lower part structure according to the embodiment is applied;

FIG. 3 is a sectional view from an inner side in a vehicle width direction (sectional view taken along line 3-3 in FIG. 1), schematically showing the configuration of the lower part of the vehicle body of the vehicle to which the vehicle lower part structure according to the embodiment is applied; and

FIG. 4 is a sectional view from the vehicle rear side (sectional view taken along line 4-4 in FIG. 1), schematically showing the configuration of a rocker of the vehicle to which the vehicle lower part structure according to the embodiment is applied.

### DETAILED DESCRIPTION OF EMBODIMENTS

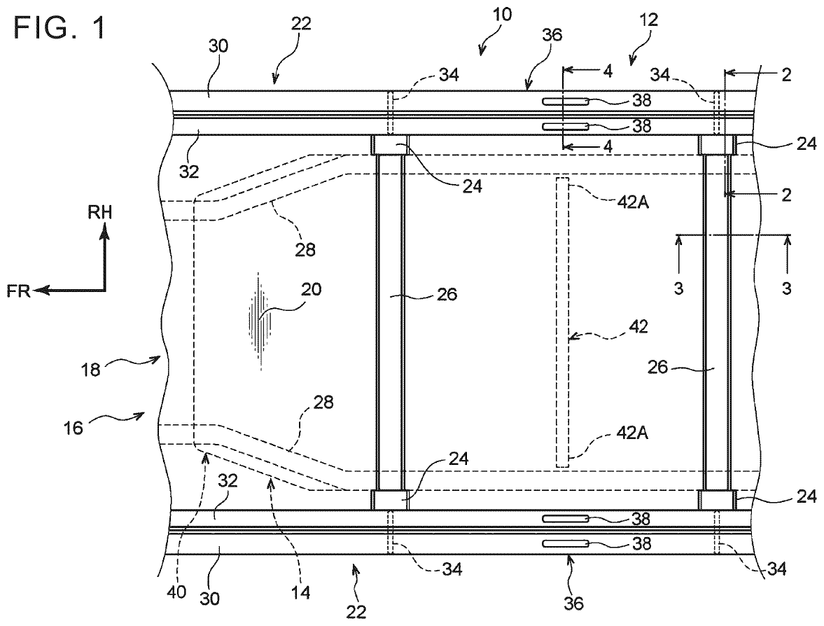

Hereinafter, an exemplary embodiment of a vehicle lower part structure according to the present disclosure will be described with reference to FIGS. 1 to 4. An arrow FR indicates a vehicle front side, an arrow UP indicates a vehicle upper side, and an arrow RH indicates a right side in a vehicle width direction. These arrows appear as appropriate in the drawings.

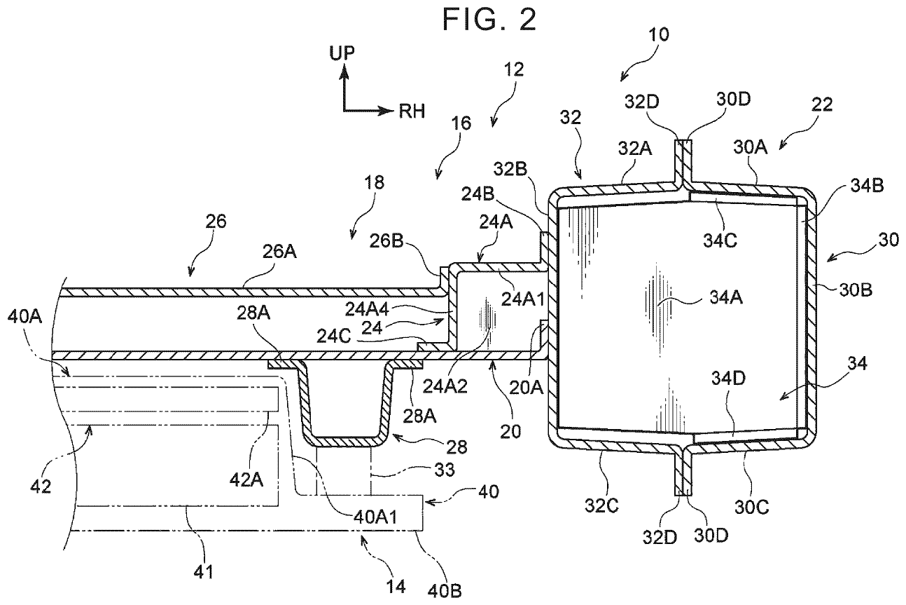

A schematic configuration of a “vehicle 10” to which the vehicle lower part structure according to the present embodiment is applied will be described first with reference to FIGS. 1 and 2. Since the vehicle 10 basically has a bilaterally symmetrical configuration, the following description in the present embodiment will focus on the configuration of the vehicle 10 on the right side in the vehicle width direction, and description will be omitted as appropriate for the configuration on the left side in the vehicle width direction.

The vehicle 10 includes a vehicle body 12, a power unit such as a motor (not shown) mounted on the vehicle 10, and a “battery pack 14” attached to the vehicle body 12. The power unit is driven with electric power supplied from the battery pack 14, and the vehicle 10 travels on a driving force generated by this power unit.

The vehicle body 12 has a “vehicle cabin 16”, and part of the vehicle cabin 16 on the vehicle lower side is a floor portion 18. The floor portion 18 includes a floor panel 20, a “rocker 22”, a “support portion 24”, a “floor cross member 26” serving as a support framework, and a side member 28. The “floor cross member 26” is an example of the “support framework” in the present disclosure.

Specifically, the floor panel 20 is formed by pressing a steel plate, and extends in a vehicle front-rear direction and in the vehicle width direction when viewed in a vehicle up-down direction. On the outer side of the floor panel 20 in the vehicle width direction, a pair of right and left rockers 22 is disposed on the outer peripheral edge of the floor panel 20 in the vehicle width direction along the vehicle front-rear direction.

The rocker 22 is made of steel, extends in the vehicle front-rear direction, and includes an outer rocker panel 30 constituting an outer part of the rocker 22 in the vehicle width direction, and an inner rocker panel 32 constituting an inner part of the rocker 22 in the vehicle width direction.

Specifically, the outer rocker panel 30 includes an upper wall portion 30A constituting a part on the vehicle upper side, a side wall portion 30B constituting an outer part in the vehicle width direction, a lower wall portion 30C constituting a part on the vehicle lower side, and a pair of flange portions 30D. The sectional shape of the outer rocker panel 30 viewed in the vehicle front-rear direction is a hat shape that is open on an inner side in the vehicle width direction.

The inner rocker panel 32 includes an upper wall portion 32A constituting a part on the vehicle upper side, a side wall portion 32B constituting an inner part in the vehicle width direction, a lower wall portion 32C constituting a part on the vehicle lower side, and a pair of flange portions 32D. The sectional shape of the inner rocker panel 32 viewed in the vehicle front-rear direction is a hat shape that is open on an outer side in the vehicle width direction. An outer end 20A of the floor panel 20 in the vehicle width direction is joined to the side wall portion 32B at a joint portion (not shown) by welding etc.

The flange portion 30D of the outer rocker panel 30 and the flange portion 32D of the inner rocker panel 32 are joined at a joint portion (not shown) by welding etc. Therefore, the rocker 22 has a closed sectional structure in which the sectional shape viewed in the vehicle front-rear direction is a substantially hexagonal closed sectional shape.

A “bulkhead 34” serving as a load transmitting member is disposed inside the rocker 22. The “bulkhead 34” is an example of the “load transmitting member” in the present disclosure. The bulkhead 34 includes a main plate portion 34A constituting a main part of the bulkhead 34, an outer flange portion 34B, an upper flange portion 34C, and a lower flange portion 34D.

Specifically, the main plate portion 34A has a rectangular plate shape when viewed in the vehicle front-rear direction, partitions the inside of the rocker 22 in the vehicle front-rear direction, and the inner end in the vehicle width direction is in contact with the side wall portion 32B of the inner rocker panel 32.

The outer flange portion 34B extends in the vehicle front-rear direction from the outer peripheral edge of the main plate portion 34A in the vehicle width direction, and is joined to the side wall portion 30B of the outer rocker panel 30 at a joint portion (not shown) by welding etc.

The upper flange portion 34C extends in the vehicle front-rear direction from the peripheral edge of the main plate portion 34A on the vehicle upper side, and is joined to the upper wall portion 30A of the outer rocker panel 30 at a joint portion (not shown) by welding etc.

The lower flange portion 34D extends in the vehicle front-rear direction from the peripheral edge of the main plate portion 34A on the vehicle lower side, and is joined to the lower wall portion 30C of the outer rocker panel 30 at a joint portion (not shown) by welding etc.

A pair of the bulkheads 34 structured as described above is disposed in each rocker 22 at a predetermined distance in the vehicle front-rear direction, and is capable of transmitting a load input to the rocker 22 in the vehicle width direction to the support portion 24.

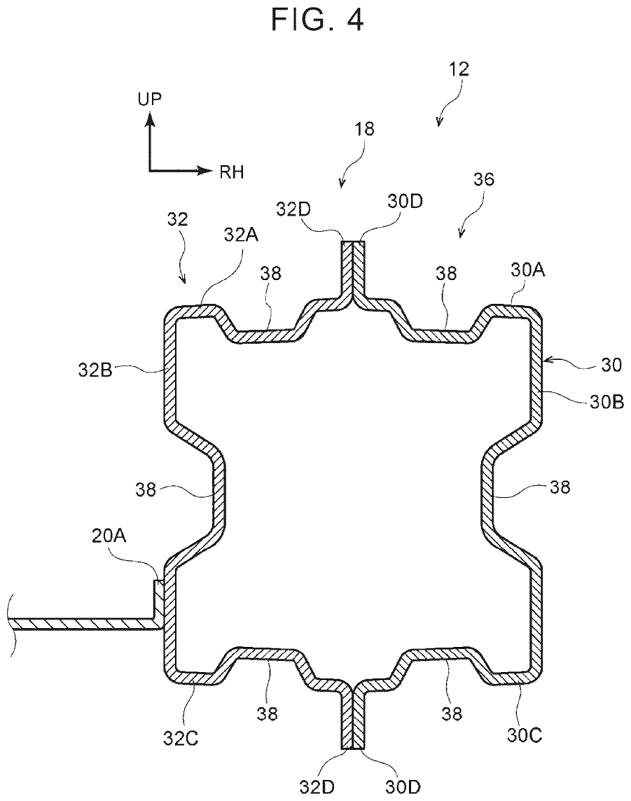

The rocker 22 includes a “weakened portion 36” at the center in the vehicle front-rear direction between the portions where the bulkheads 34 are provided. As also shown in FIG. 4, the weakened portion 36 is structured by forming recesses 38 extending in the vehicle front-rear direction in the upper wall portion 30A, the side wall portion 30B, and the lower wall portion 30C of the outer rocker panel 30 and the upper wall portion 32A, the side wall portion 32B, and the lower wall portion 32C of the inner rocker panel 32.

The second moment of area about a neutral axis of a cross section of the weakened portion 36 viewed in the vehicle front-rear direction is smaller than the second moment of area about a neutral axis of a cross section of the other part of the rocker 22 viewed in the vehicle front-rear direction. That is, the rigidity (bending rigidity) of the weakened portion 36 against a load in the vehicle width direction is lower than the rigidity of the other part of the rocker 22.

As shown in FIG. 1, on the vehicle upper side of the floor panel 20, the support portion 24 is disposed on the inner side in the vehicle width direction with respect to each portion of the rocker 22 where the bulkhead 34 is provided. That is, a pair of the support portions 24 is disposed for each rocker 22 at a predetermined distance in the vehicle front-rear direction. The support portions 24 are disposed at the same position in the vehicle width direction.

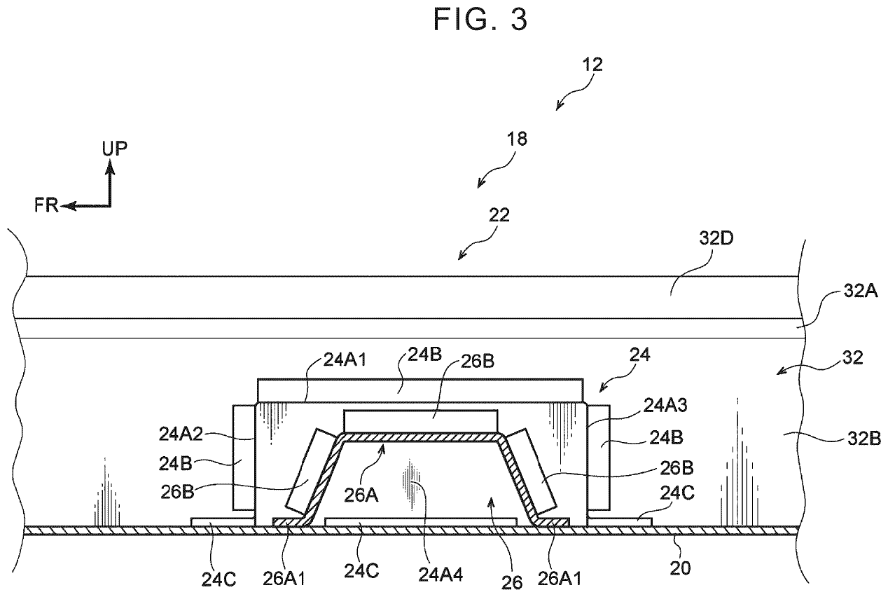

Specifically, as shown in FIGS. 2 and 3, the support portion 24 includes a body 24A constituting a main part of the support portion 24, an outer flange portion 24B, and a lower flange portion 24C.

The body 24A includes an upper wall portion 24A1 constituting a part on the vehicle upper side, a front wall portion 24A2 constituting a part on the vehicle front side, a rear wall portion 24A3 constituting a part on the vehicle rear side, and an inner wall portion 24A4 constituting an inner part in the vehicle width direction. The outer shape of the body 24A is a rectangular parallelepiped shape with its longitudinal direction corresponding to the vehicle front-rear direction.

The outer flange portion 24B extends with its thickness direction corresponding to the vehicle width direction from each of the outer peripheral edge of the upper wall portion 24A1 in the vehicle width direction, the outer peripheral edge of the front wall portion 24A2 in the vehicle width direction, and the outer peripheral edge of the rear wall portion 24A3 in the vehicle width direction. The outer flange portion 24B is joined to the side wall portion 32B of the inner rocker panel 32 at a joint portion (not shown) by welding etc.

The lower flange portion 24C extends with its thickness direction corresponding to the vehicle up-down direction from each of the peripheral edge of the front wall portion 24A2 on the vehicle lower side, the peripheral edge of the rear wall portion 24A3 on the vehicle lower side, and the peripheral edge of the inner wall portion 24A4 on the vehicle lower side. The lower flange portion 24C is joined to the floor panel 20 at a joint portion (not shown) by welding etc.

The floor cross member 26 is made of steel, extends in the vehicle width direction on the inner side of the support portion 24 in the vehicle width direction, and includes a body 26A constituting a main part of the floor cross member 26, and an outer flange portion 26B.

The sectional shape of the body 26A viewed in the vehicle width direction is a hat shape that is open on the vehicle lower side, and a flange portion 26A1 is joined to the floor panel 20 at a joint portion (not shown) by welding etc. The body 26A joined to the floor panel 20 constitutes a closed sectional structure together with the floor panel 20.

The outer flange portion 26B extends with its thickness direction corresponding to the vehicle width direction from the outer peripheral edge of the body 26A in the vehicle width direction. The outer flange portion 26B is joined to the inner wall portion 24A4 of the support portion 24 at a joint portion (not shown) by welding etc. The floor cross member 26 is disposed so that its main part overlaps the support portion 24 when viewed in the vehicle width direction.

As shown in FIG. 2, the side member 28 is made of steel, extends in the vehicle front-rear direction, and is disposed on the vehicle lower side of the floor panel 20 on each side of the floor panel 20 in the vehicle width direction. The side member 28 is positioned on the inner side of the rocker 22 in the vehicle width direction.

The sectional shape of the side member 28 viewed in the vehicle front-rear direction is a hat shape that is open on the vehicle upper side, and a flange portion 28A is joined to the floor panel 20 at a joint portion (not shown) by welding etc. The side member 28 joined to the floor panel 20 constitutes a closed sectional structure together with the floor panel 20. In the present embodiment, the battery pack 14 is attached to the side member 28.

As shown in FIGS. 1 and 2, the battery pack 14 is positioned on the vehicle lower side with respect to the vehicle cabin 16, and includes a battery case 40 with its main part made of an aluminum alloy, and a “battery cell 41” disposed inside the battery case 40.

The battery case 40 includes a body 40A that houses the battery cell 41, and a base 40B constituting a part on the vehicle lower side. The battery case 40 is fixed to the vehicle body 12 by attaching the base 40B to the side member 28 using an attachment member (not shown) with the main part of the body 40A fitted between the side members 28 and with a mounting member 33 interposed between the base 40B and each side member 28. Part of the battery pack 14 overlaps the rocker 22 when viewed in the vehicle width direction.

The battery case 40 is reinforced by a “battery cross member 42” provided on the inside as a central framework. The “battery cross member 42” is an example of the “central framework” in the present disclosure. The battery cross member 42 is an aluminum alloy extrusion having a rectangular tube shape extending in the vehicle width direction, and is spanned between parts on the vehicle upper side in side wall portions 40A1 on the outer side of the body 40A in the vehicle width direction. The rigidity of the floor cross member 26 against a load in the vehicle width direction is higher than the rigidity of the battery cross member 42 against the load.

The battery cross member 42 is positioned between the support portions 24 in the vehicle front-rear direction, and overlaps the weakened portion 36 of the rocker 22 when viewed in the vehicle width direction. It may also be said that the disposition position of the battery cross member 42 and the disposition position of the weakened portion 36 are set as the same position in the vehicle front-rear direction. An “end 42A” of the battery cross member 42 is positioned on the inner side in the vehicle width direction with respect to the support portion 24.

When viewed in the vehicle up-down direction, the main part of the support portion 24 is disposed between the battery cross member 42 and the rocker 22 in the vehicle width direction.

### Actions and Effects of Embodiment

Next, actions and effects of the present embodiment will be described.

In the present embodiment, as shown in FIG. 2, the battery pack 14 is disposed on the vehicle lower side with respect to the vehicle cabin 16, and includes the battery cell 41 inside. The rocker 22 extending in the vehicle front-rear direction is disposed on the outer side of the battery pack 14 in the vehicle width direction. Therefore, when a collision load is input in the vehicle width direction, the collision load is input to the rocker 22 before being input to the battery pack 14.

When the collision load is input in the vehicle width direction, this collision load may be input to the battery cell 41 in the battery pack 14 depending on a deformation mode of the rocker 22.

In the present embodiment, the pair of support portions 24 is provided for one rocker 22. At least part of the support portion 24 is disposed between the battery pack 14 and the rocker 22 in the vehicle width direction when viewed in the vehicle up-down direction, and the support portions 24 are disposed away from each other in the vehicle front-rear direction.

As shown in FIG. 1, the battery cross member 42 extending in the vehicle width direction is positioned between the support portions 24 in the vehicle front-rear direction, and the end 42A of the battery cross member 42 is positioned on the inner side in the vehicle width direction with respect to the support portions 24.

Therefore, when the collision load is input to the rocker 22 in the vehicle width direction, the rocker 22 supported by the support portions 24 is bent so that, when viewed in the vehicle up-down direction, the apex of the rocker 22 is near the center of the portion of the rocker 22 between the support portions 24 in the vehicle front-rear direction. In the present embodiment, the vicinity of the apex of the rocker 22 deformed by the collision load can be supported by the battery cross member 42, thereby suppressing transmission of the collision load toward the battery cell 41.

In the present embodiment, the floor cross member 26 is provided. The floor cross member 26 extends in the vehicle width direction on the inner side of the support portion 24 in the vehicle width direction, and is disposed to overlap the support portion 24 when viewed in the vehicle width direction.

Therefore, in the present embodiment, when the collision load is input in the vehicle width direction, part of the load input to the support portion 24 can be borne by the floor cross member 26.

In the present embodiment, the vicinity of the apex of the rocker 22 deformed by the collision load in the vehicle width direction can be supported by the battery cross member 42 provided inside the battery pack 14. That is, in the present embodiment, the collision load can also be borne by the component inside the battery pack 14.

Depending on the rigidity of the floor cross member 26 against the collision load in the vehicle width direction, there is a possibility that, when the collision load is input to the rocker 22, the rocker 22 cannot maintain the support by the floor cross member 26 and the entire rocker 22 is pushed inward in the vehicle width direction.

In the present embodiment, the rigidity of the floor cross member 26 against the load in the vehicle width direction is higher than the rigidity of the battery cross member 42 against the load. This can increase the certainty that, when the load is input in the vehicle width direction, the load is borne by the floor cross member 26, and furthermore, increase the certainty that the vicinity of the apex of the rocker 22 bent by the vehicle collision load is supported by the battery cross member 42.

In the present embodiment, the weakened portion 36 is provided at the part of the rocker 22 positioned between the support portions 24 in the vehicle front-rear direction. The rigidity of the weakened portion 36 against the load in the vehicle width direction is lower than the rigidity of the other part of the rocker 22. Therefore, the present embodiment can increase the certainty that, when the collision load is input to the rocker 22 in the vehicle width direction, the rocker 22 is deformed at a point starting from the weakened portion 36. Thus, the deformation mode of the rocker 22 can be managed more easily.

In the present embodiment, the disposition position of the battery cross member 42 and the disposition position of the weakened portion 36 of the rocker 22 are set as the same position in the vehicle front-rear direction, thereby increasing the certainty that the vicinity of the apex of the rocker 22 deformed by the collision load in the vehicle width direction is supported by the battery cross member 42.

In the present embodiment, as shown in FIG. 2, the bulkhead 34 is disposed inside the rocker 22. The bulkhead 34 is capable of transmitting the load in the vehicle width direction to the support portion 24. Therefore, in the present embodiment, when the collision load is input in the vehicle width direction, part of the collision load can be transmitted to the support portion 24 via the bulkhead 34 even if the rocker 22 is deformed by the collision load.

As described above, in the present embodiment, the input of the collision load in the vehicle width direction to the battery cell 41 in the battery pack 14 can be suppressed by managing the deformation mode of the rocker 22.

### Supplementary Description of Embodiment

(1) In the above embodiment, the vicinity of the apex of the rocker 22 deformed by the collision load in the vehicle width direction is supported by the battery cross member 42 provided inside the battery pack 14, but the configuration of the vehicle 10 is not limited to this. For example, depending on the specifications of the vehicle 10, a floor cross member instead of the battery cross member 42 may be disposed between the side members 28 on the vehicle lower side of the floor panel 20.

(2) In the above embodiment, the support portion 24 is provided on the vehicle upper side of the floor panel 20. Depending on the specifications of the vehicle 10, the support portion 24 may be interposed between the rocker 22 and the side member 28 on the vehicle lower side of the floor panel 20. When such a configuration is adopted, the floor cross member 26 may be spanned between the rockers 22.

What is claimed is:

1. A vehicle lower part structure comprising:
a battery pack including a battery cell inside and disposed on a vehicle lower side with respect to a vehicle cabin of a vehicle;
a rocker disposed on an outer side of the battery pack in a vehicle width direction and extending in a vehicle front-rear direction;
a pair of support portions disposed at least partially between the battery pack and the rocker in the vehicle width direction when viewed in a vehicle up-down direction, and spaced away from each other in the vehicle front-rear direction; and
a central framework extending in the vehicle width direction, positioned between the support portions in the vehicle front-rear direction, and including an end positioned on an inner side in the vehicle width direction with respect to the support portions.

2. The vehicle lower part structure according to claim 1, further comprising a support framework extending in the vehicle width direction on an inner side of the support portion in the vehicle width direction, and disposed to overlap the support portion when viewed in the vehicle width direction.

3. The vehicle lower part structure according to claim 2, wherein the central framework is a battery cross member provided inside the battery pack.

4. The vehicle lower part structure according to claim 3, wherein a rigidity of the support framework against a load in the vehicle width direction is higher than a rigidity of the battery cross member against the load.

5. The vehicle lower part structure according to claim 1, wherein the rocker includes a weakened portion provided at a part positioned between the support portions in the vehicle front-rear direction, and having a lower rigidity against a load in the vehicle width direction than another part of the rocker.

6. The vehicle lower part structure according to claim 5, wherein a disposition position of the central framework and a disposition position of the weakened portion are set as the same position in the vehicle front-rear direction.

7. The vehicle lower part structure according to claim 1, further comprising a load transmitting member disposed inside the rocker and configured to transmit a load in the vehicle width direction to the support portion.
